(19) United States
(12) Patent Application Publication
(10) Pub. No.: US 2007/0218248 A1
(43) Pub. Date: Sep. 20, 2007

(54) Multi-Ply Tissue Paper

(76) Inventors: Anna Mansson, Molndal (SE); Jan-Peter Brunback, Torslanda (SE); Sven Gross, Ebbs (AT); Thami Chihani, Molnlycke (SE)

Correspondence Address: YOUNG & THOMPSON, 745 SOUTH 23RD STREET, 2ND FLOOR, ARLINGTON, VA, 22202, US

(21) Appl. No.: 10/591,399

(22) PCT Filed: Mar. 4, 2004
(86) PCT No.: PCT/SE04/00308

§ 371 Date: Mar. 12, 2007

(51) Int. Cl. B32B 29/04

(52) U.S. Cl. 428/114; 162/202

(57) ABSTRACT

A tissue paper (1) includes at least two plies (2,3,4). At least a first ply (2) of the plies includes pattern of areas (6), in which fibres protrude outside the plane of the ply in a direction towards the second of the at least two plies. A method for producing such a tissue paper is also disclosed.

### TECHNICAL FIELD

The present invention relates to a tissue paper comprising at least two plies and a method for producing such a tissue paper.

### BACKGROUND OF THE INVENTION

Household towels should be effective both for dry and wet wiping. For aesthetic reasons such towels are often provided with pattern of embossments. Such embossed towels are more effective for wiping applications than towels without embossments, probably because they have a specific outer surface. The amount of liquid that can be drawn into a paper towel is also dependent of the bulk of the paper, the higher the bulk, the higher the amount of liquid. In order to take full advantage of a towel having a high bulk in dry condition, the bulky structure of the towel must be maintained also in wet condition of the towel. However, the embossed parts of towels have a tendency to collapse when wet, thereby reducing the absorption capacity of the towels.

The present invention addresses these problems.

From EP-A1-0 959 164 it is known that by raising fibres with the aid of mechanical means, such as needles, from at least one outer surface of a nonwoven fabric, a highly effective wiping sheet for both dry wiping and wet wiping can be produced. However, such a solution can not be used for tissue paper lacking the hydrophobic fibres of such nonwoven fabric, maintaining the bulkiness of the nonwoven fabric in a wet condition.

The objective of the present invention is to provide a tissue paper with increased absorption capacity, increased bulk and good stability in wet condition.

### SUMMARY OF THE INVENTION

This objective is accomplished by a tissue paper comprising at least two plies, characterised in that at least a first ply of said plies comprises pattern of areas, in which fibres protrude outside the plane of said ply in a direction towards the second of the at least two plies. In such a tissue paper liquid drawn into the paper can be stored in voids created around the areas of protruding fibres and the planar parts of the first ply and second ply, the absorption capacity thereby being increased in relation to a tissue paper without such protruding areas. The bulky structure of such a tissue paper will to a great extent be retained in wet condition of the paper due to fibres in the protruding areas being directed in a direction essentially perpendicular to the plane of the first ply.

In a preferred embodiment the sum of said areas, in which fibres protrude outside the plane of said ply in a direction towards the second of the at least two plies, is between 0.25-20%, preferably 0.5-15%, more preferably 1-10% of the total area of the tissue paper and said pattern in the at least one ply comprises a pattern of holes, the walls around said holes protruding outside the plane of said ply. Such walls will have fibres which ends rest on a surface of the second ply, thereby effectively resisting collapse of such fibres when wet.

In a preferred variant the plies are stretchable and each ply have a different stretchability than an adjacent ply, the difference in stretchability between adjacent plies being at least 5%, preferably at least 8% and most preferably at least 10%.

Preferably, the paper comprises three plies and the middle ply has greater stretchability than the outer plies.

The invention also relates to a method of producing tissue paper starting from at least two plies of tissue, characterised by providing at least a first ply with a pattern of areas, in which fibres protrude outside the plane of said ply, with the aid of mechanical means, and bonding the at least two plies together with the areas of fibres protruding outside the plane of the first ply in a direction towards an adjacent ply.

In a preferred embodiment, said pattern of protruding areas of fibres is produced by providing a pattern of holes in said ply and mechanically forcing an area of paper around each hole out of the plane of said ply. Said pattern of holes and the forcing of paper can to advantage be accomplished with the aid of a needled embossing roll, wherein a brush roll is provided as a counter-roll to the needled embossing roll.

### BRIEF DESCRIPTION OF THE DRAWINGS

The invention will now be described with reference to the enclosed figures, of which;

FIG. 1 shows a schematic sectional view of a multi-ply tissue paper according to a preferred embodiment of the invention,

FIG. 2 shows a schematic plan view of the middle ply in the multi-ply tissue paper in FIG. 1,

FIG. 3 shows a sectional view along line III-III in FIG. 2,

FIG. 4 illustrates schematically a process line for manufacturing the multi-ply tissue paper of shown in FIG. 1,

FIG. 5 illustrates in larger detail the perforation of a ply of tissue paper.

### DESCRIPTION OF EMBODIMENTS

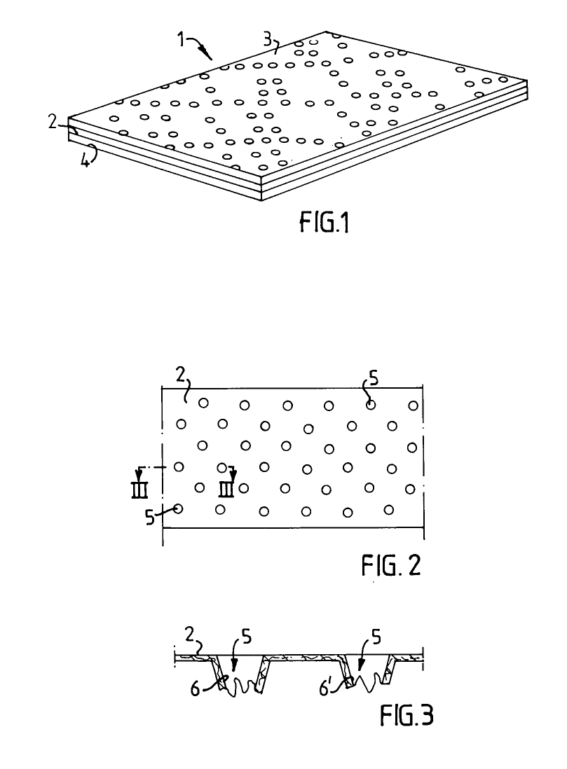

In FIGS. 1-3, a household towel 1 comprising a multi-ply tissue paper according to a preferred embodiment of the invention is schematically disclosed. This paper 1 is comprised of three plies, one middle ply 2 and two outer plies, bonded to the middle ply.

In the preferred embodiment, the middle ply is provided with a pattern of holes 5 having conical walls 6 protruding out of the plane of the middle ply 2. The size of the holes in the plane of the ply 2 is between 0.1-20 mm². The height of the walls 6 protruding out of the plane of the ply 2 is proportional to the dimension of the holes in a direction perpendicular to the machine direction. The sum of areas of the holes in the plane of ply 2 is between 0.25-20%, preferably 0.5-15%, more preferably 1-10% of the total area of the ply.

The outer plies 3,4 are provided with a pattern of embossments, as schematically indicated in FIG. 1 for ply 3. The embossments in the outer plies 3,4 can be made by several known embossing techniques but so-called nested embossing is preferred.

The basic idea behind the invention is to improve the absorption capacity and the wet stability of a tissue paper by directing fibres in the paper in a direction out of the plane of the paper. This can be done by creating a pattern of protrusions in the surface of the ply or plies, for example by creping or embossing dry tissue paper or by using a patterned forming wire during the forming process. For a multi-ply tissue paper in which at least one ply has such a pattern of protrusions turned against an adjacent ply, a lot of voids will be created between said plies around those protrusions. If said protrusions are maintained in a wet condition of the multi-ply paper, liquid can be stored in these voids, the absorption capacity of the paper then being increased. In order to enhance the wet properties of such protrusions, wet strength additives or the like is preferably be added to the paper, at least in the areas of such protrusions.

It has surprisingly been found that the wet stability of such a multi-ply paper and thereby the absorption capacity thereof is enhanced if a pattern of holes having protruding walls is provided in a ply thereof. It is believed that this is due to the creating of a lot of fibre ends abutting the adjacent ply to which the hole-containing ply is attached. Such a fibre seems not to collapse as easy when wet, as fibres having ends directed away from or parallel to the adjacent ply.

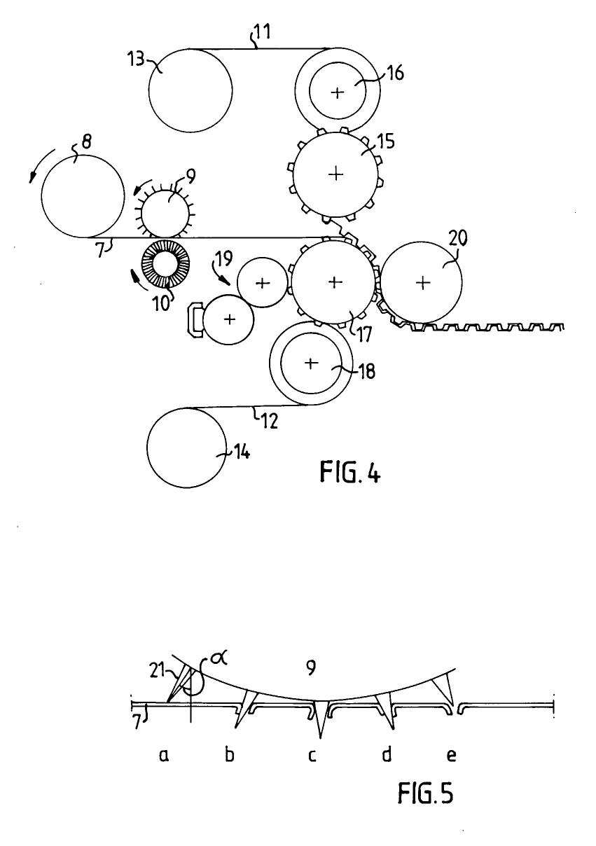

In FIG. 4 a process line for producing the multi-ply tissue of FIG. 1 is schematically shown. A first web 7 of dry tissue paper is drawn from a storage roll 8. This paper has a stretchability of 22%, i.e. it can be elongated 22%, the paper is for example creped. The value of 22% is given only as example and the stretchability of web 7 can lie between 2-40%. Web 7 is then passed through the nip between a hole making roll 9 and a counter-roll 10. In the preferred embodiment, the hole-making roll 9 has a pattern of conical needles protruding around the circumference thereof and the counter-roll 10 is a brush roll with bristles being easily bent away by the needles but stiff enough to press the web 7 against the circumferential wall of hole-making roll in the nip between rolls 9 and 10.

Downstream of the hole-making roll 9 the first web 7 is brought together with second and third embossed webs 11,12 having different stretchabilities than web 7, for example 12% for both of these webs 11,12. The webs 11 and 12 have been drawn from storage rolls 13 and 14, respectively and passed through the nip between embossing rolls 15 and 17, respectively and counter rolls 16 and 18, respectively, the counter rolls being rubber rolls for example. Glue is applied to the protruding tops of the second or third web upstream of the point at which the three webs 7,11,12 are brought together by a glue application device 19 of known construction. In the shown embodiment glue is applied to the tops of the protruding embossments on the third web 12 running on embossing roll 17 but glue could be applied to the second web 11 instead. The three webs 7,11,12 brought together on the embossing roll 17 then pass the nip between this roll and a counter roll 20, a marry roll, in order to bond the webs together. As can be seen in FIG. 4, the tops of the embossments of the third web 12 are bonded to non-protruding parts of the embossed second web 11.

After leaving rolls 17,20 the web of three-ply tissue paper 7,11,12 is preferably rolled on a storage roll. However, other operations, such as dividing the web of tissue paper into single hand towels or providing the web with successive perforation lines can be made before packaging and storing of single hand towels or rows of household towels.

The webs 7,11,12 preferably contain wet strength agents, such as polyamide-amine-epichlorohydrin resins, cross-linked polymer formaldehyde resins or aldehyde derivatives of polyamide resins.

By the described process is obtained a multi-ply tissue paper 7,11,12 with a high bulk, good absorption capacity and good wet stability as well as a attractive appearance with more or less planar embossed outer surfaces with the embossments directed towards the middle web 7 provided with a pattern of holes. Such a tissue paper is suitable for the use as household towels.

In FIG. 5 the hole-making of web 7 is schematically illustrated. The needles 21 on the hole-making roll 9 are shown in positions a-e during the passage of web 7 past the rolls 9,10. At position a, the needle comes into contact with the web 7 and makes a small hole therein. As can be seen in FIG. 5 the needle will have an inclination other than perpendicular to the web 7. Moreover, the periphery rate, at which the nose of the needle 21 moves is slightly higher than the periphery rate, at which the outer surfaces of rolls 9,10 move and at which the web 7 moves. Thereby, the needle moves slightly faster than the paper web and will thus exert a tearing force on the paper. At position b, the needle has penetrated a distance through the paper and the velocity of the needle in the part in contact with the web is closer to the velocity of the web than in position a. At position c, the needle is fully penetrated into the paper web 7 and the line in contact with the web moves with the same velocity as the web. At positions d and e, the contact line of the needle moves at a higher velocity than the web, the velocities at these points corresponding to the velocities at points a and b, respectively. During the movement cycle in contact with the paper web, the conical needle is from positions a-c successively penetrating into the web and from positions c-e successively drawn out of contact with the web. If, which is preferred in the disclosed embodiment, the cone angle of the needles is such that the diameter of the needle at the base thereof corresponds to the distance which the nose of the needle 21 has travelled relative to web 7 from position a to position c, the hole created in the web will have essentially circular openings in the plane of the web. As is evident from FIG. 5, such a relationship will occur if the cone angle corresponds to the angle between the needle at position a and a line perpendicular to the web. The walls protruding downwards from the plane of the web will be divided into at least two portions separated from each other by tear lines. The occurrence of such tear lines is dependent on the local strength in the web and will therefore vary from hole to hole. It is to be noted that the folding down of the walls and thus the height of the walls is essentially depending on the dimension of needles, when inserted, in a cross direction relative the machine direction (the direction of travel of the web 7). The dimension of the holes and the average height of the protruding walls can thus be varied by varying the penetrating length or the cross dimension of the needles.

### EXAMPLES

The absorption capacity, tensile strength in the machine (MD) and cross direction (CD) and wet strength in the cross direction of a three-ply tissue paper according to the present invention have been compared with two reference tissue paper. All the three-ply tissue papers were embossed with a pattern comprising 6.48 embossments per cm² on one of the outer plies and 7.62 embossments per cm² on the opposite outer ply, the embossing being made with a low pressure (⅔ bar) and a high pressure (⅘ bar) by the so-called nested embossing method.

The absorption capacity was measured by a modified standard method DIN 54540-4, the modification involving a corner of a 10×10 cm sample hanging down instead of a side. Basis weight was measured by the standard method EN 12625-6, tensile strength in dry condition by standard method EN 12625-4 and in wet condition by standard method EN 12625-5.

All the samples had a middle ply which had been provided with a pattern of holes made by conical needles having a cone angle of 4°. The sum of hole areas were 3.4%, the holes having a diameter of 0.8-1.2 mm in the plane of the middle ply.

Reference 1 and 3 and sample 1 and 3 were embossed at low pressure and reference 2 and 4 and sample 2 and 4 were embossed at high pressure. Furthermore, samples 3 and 4 were comprised of stretchable plies, the middle ply had a stretchability of 22% and the outer plies a stretchability of 12%. The plies in references 1-4 and in samples 1 and 2 had a stretchability of 17%.

All the tissue papers in table 1, i.e. reference 1 and 2 and sample 1 and 2 were made from the same raw paper.

The results are shown below in tables 1 and 2.

TABLE 1

| | Ref 1 | Ref 2 | Sample 1 | Sample 2 |
|---|---|---|---|---|
| Absorption | 275 | 301 | 303 | 340 |
| capacity (g/m²) | | | | |
| Basis weight | 53.7 | 53.0 | 53.3 | 52.8 |
| (g/m²) | | | | |
| MD tensile | 24.3 | 19.7 | 22.8 | 16.4 |
| strength, dry | | | | |
| N/50 mm | | | | |
| CD tensile | 14.0 | 10.0 | 14.2 | 9.9 |
| strength, dry | | | | |
| N/50 mm | | | | |
| CD tensile | 3.1 | 2.1 | 3.0 | 2.1 |
| strength, wet | | | | |
| N/50 mm | | | | |

From table 1 it is evident that the hole-making according to the invention of a three-ply tissue paper results in an increase in absorption capacity of more than 10%. Moreover, although the tensile strength in the machine direction decreases somewhat by the hole-making of the middle ply, the strength in cross direction is not influenced by the hole-making of the middle ply neither in dry or wet condition of the tissue paper.

TABLE 2

| | Ref 3 | Ref 4 | Sample 3 | Sample 4 |
|---|---|---|---|---|
| Absorption | 264 | 282 | 331 | 348 |
| capacity (g/m²) | | | | |
| Basis weight | 53.7 | 52.6 | 53.3 | 52.8 |
| (g/m²) | | | | |
| MD tensile | 25.3 | 18.9 | 18.6 | 12.7 |
| strength, dry | | | | |
| N/50 mm | | | | |
| CD tensile | 14.7 | 10.3 | 13.2 | 8.1 |
| strength, dry | | | | |
| N/50 mm | | | | |
| CD tensile | 3.2 | 2.4 | 2.7 | 1.8 |
| strength, wet | | | | |
| N/50 mm | | | | |

From table 2 it is evident that the absorption capacity is further increased about 10% when adjacent plies in the three-ply tissue paper have different stretchability. This is believed to be caused by the irregularities in the surfaces of the plies creating further voids between the plies for storage of liquid. This effect is increased by the outer plies having different stretchability than the middle ply. An effect of making the plies stretchable is that the strength of the three-ply tissue paper decreases, as is evident from table 2.

The embodiment shown can be modified in several aspects within the scope of the present invention. For example, the needles can have other sectional shapes than circular, such as half-spherical, oval, triangular, rectangular, rhomboidal, etc. Furthermore, the needles need not have an increasing sectional area in a direction towards the roll, to which they are attached, and need not have a continuous shape. For example, a sharp thin nose can protrude from a pyramidal base portion. Moreover, two hole-making rolls can be used to needle the middle ply from both sides. The outer plies can be provided with a pattern of holes as well or instead of the middle ply, thereby increasing the absorption rate of the tissue paper due to the capillarity of the holes, even if this is not preferred due to aesthetic considerations. The multi-ply tissue paper according to the invention can have less or more than three plies. The plies in a multi-ply tissue paper according to the invention need not be separate from each other but can consist of a single ply provided with a pattern of holes over at least a part thereof being folded to a tissue paper having two or more plies. If the multi-ply tissue paper according to the invention has more than three plies, all plies except the two outer plies are preferably provided with patterns of holes. The plies can be bonded together in other ways than described, for example by spraying a pattern of adhesive onto one of the plies before putting two plies together or by passing plies put together through an ultra-sonic device. Other known methods, such as foot-to-foot embossing, steel-to-steel embossing or edge embossing can be used to join together the plies. The invention should therefore only be restricted by the content of the enclosed patent claims.

1. A tissue paper (1) comprising at least two plies (2, 3, 4), characterised in that at least a first ply (2) of said plies comprises pattern of areas (6), in which fibres protrude outside the plane of said ply in a direction towards the second of the at least two plies.

2. The tissue paper according to claim 1, wherein the sum of said areas (6), in which fibres protrude outside the plane of said ply (2) in a direction towards the second (4) of the at least two plies, is between 0.25-20%, preferably 0.5-15%, more preferably 1-10%, of the total area of the tissue paper (1).

3. The tissue paper according to claim 1, wherein said pattern in the at least one ply (2) comprises a pattern of holes (5), the walls (6) around said holes protruding outside the plane of said ply.

4. The tissue paper according to claim 1, wherein the plies (2,3,4) are stretchable and each ply have a different stretchability than an adjacent ply.

5. The tissue paper according to claim 4, wherein the difference in stretchability between adjacent plies (2,3,4) is at least 5%, preferably at least 8% and more preferably at least 10%.

6. The tissue paper according to claim 5, wherein the paper comprises three plies (2,3,4) and the middle ply (2) has greater stretchability than the outer plies (3,4) or vice versa.

7. The tissue paper according to claim 6, wherein the ply comprising the lowest stretchability has a stretchability of at least 10%.

8. A method of producing tissue paper (7,11,12) starting from at least two plies of tissue (7,12), characterised by providing at least a first ply (7) with a pattern of areas, in which fibres protrude outside the plane of said ply, with the aid of mechanical means, and bonding the at least two plies together with the areas of fibres protruding outside the plane of the first ply in a direction towards an adjacent ply.

9. The method according to claim 8, wherein said pattern of protruding areas of fibres is produced by providing a pattern of holes in said ply (7) and mechanically forcing an area of paper around each hole out of the plane of said ply.

10. The method according to claim 9, wherein said pattern of holes and forcing of paper is accomplished with the aid of a needled roll (9).

11. The method according to claim 10, wherein a brush roll (10) is provided as a counter roll to the needled roll.

12. The tissue paper according to claim 2, wherein said pattern in the at least one ply (2) comprises a pattern of holes (5), the walls (6) around said holes protruding outside the plane of said ply.

13. The tissue paper according to claim 2, wherein the plies (2,3,4) are stretchable and each ply have a different stretchability than an adjacent ply.

14. The tissue paper according to claim 3, wherein the plies (2,3,4) are stretchable and each ply have a different stretchability than an adjacent ply.
